(19) United States
(12) Patent Application Publication
(10) Pub. No.: US 2003/0061396 A1
(43) Pub. Date: Mar. 27, 2003

(54) System and method for processing simultaneous computer information

(75) Inventors: Sayling Wen, (US); Kuang Shin Lin, (US); Zhen Ma, (US); Bin Luo, (US)

Correspondence Address: Mitchell P. Brook, Baker & McKenzie, 12th Floor, 101 West Broadway, San Diego, CA, 92101-3890, US

(73) Assignee: Inventec Corporation

(21) Appl. No.: 09/961,530

(22) Filed: Sep. 24, 2001

(51) Int. Cl. G06F 9/46

(52) U.S. Cl. 709/313

(57) ABSTRACT

An information message processing system for processing simultaneous information messages for users of a computer running an application software program by a user under a host operating system. The information message processing system comprises a front-end unit and a back-end unit. The front-end unit comprises a user interface for interfacing the user to the computer; and the back-end unit comprises a message access request management module, a user request analysis module, a message processing module, a display send status module, and a message send/receive module. The message access request management module receives information message access requests requesting for received messages as issued by the user and relayed by the user interface, and further assigning to the user request analysis module for determining a received information message for display. The user request analysis module resolves the request and relays the resolved message to the message processing module for processing. The message processing module relays the processed message back to the user interface of the front-end unit for display to the user. The message access request management module also receives information message access requests requesting for messages to be sent as issued by the user and relayed by the user interface and assigns to the display send status module for determining an information message to be sent for display. The display send status module resolving the request and relays the resolved message to the message send/receive module for processing. The message send/receive module then relays the processed message back to the user interface of the front-end unit or display to the user.

### FIELD OF THE INVENTION

This invention relates in general to processing of computer information and, in particular, to a system for processing simultaneous information messages for users of a computer system.

### BACKGROUND OF THE INVENTION

Conventional operating systems (OS) for personal computers (PC) such as commercial Microsoft Windows and freeware Linux are in general full-fledged operating systems capable of many and various functionalities. Feature-rich and sophisticated they may be, however, those very features and sophistication themselves also constitute, on many occasions, serious psychological barriers for computer-novices. These barriers automatically arise for many novice users as they attempt to use the computer not only because the typical PC OS is complex and feature-laden, but also because there are at least several procedural steps to take before any of the more simple and intuitive computer applications can be launched and used.

To power up a computer and bring up an application, a user has to boot up the system, access the physical interface of the system via devices such as a keyboard and/or mouse, locate the whereabouts of the particular application software from the desktop icon array, and then actually launch the application.

Even after the user has successfully brought the desired software application up and running, the process of using the application will most likely involve interacting with the application via one or more of several forms of user interfaces. Sometimes, a combination of these interfaces will have to be used. Typical of these user interfaces are graphical (GUIs) and multimedia types initiated through the use of a mouse, keyboard, microphone, and the like. However, since almost all of the most popular software application programs are marketed in English versions, and even the non-English version software programs inevitably contain English messages in the interfaces they provide, for non English-speaking or barely literate users, even these popular GUIs and other multimedia interfaces constitute obstacles to computer access and productive use.

Thus, an easy-to-use computer application software system should look and feel friendly and be encouraging rather than frightening. A friendly and encouraging application system should be fool-proof in that the user knows he or she will never physically damage the computer, crash the OS, or lose data simply by attempting different commands on the computer. A simple computer application system is therefore desirable for those intending to learn and use computers for the first time and then for simple daily activities such as keeping phone numbers and addresses, web browsing, and many other intuitive applications.

### SUMMARY OF THE INVENTION

An easy-to-use application software system aimed at providing hands-on experience and initiating the learning of computer use for computer novices has the functionality for processing daily-life computer applications that a computer-novice desires. Functionalities provided by such an easy-to-use application software system include the ability to process handy personal information such as phone numbers and addresses, take notes in texts or in drawings, provide basic communication services including telephone, facsimile, electronic mailing, chatting service over the network, and access to the popular World Wide Web over the Internet. The system also provides easy-to-use application systems for convenient learning and recreational sessions such as tutoring for personal skills such as language and typing, game playing, as well as audio and video playback.

The present invention provides a system and method for processing simultaneous computer information messages for software application systems that work in a cooperative manner with a normal full-feature OS in order to provide user friendliness and an encouraging mood for computer novices or even illiterates.

Frequently, a user attempting to access electronic mail messages in both the sending and receiving services encounters the problem of being flooded by a number of simultaneous mail messages. A typical scenario of an email session is the sometimes-unexpected and instantaneous popping-up of mail messages as each one of them is subsequently received in the course of the user's mail session. Each of these received mail messages is typically presented to the user in its own display window. Further, these incoming messages are then mixed with those currently being composed for sending subsequently. Without proper care, some of the incoming mail messages may be lost due to inadvertent negligence or even unintentional discard by the user him- or herself. Meanwhile, with all incoming and outgoing messages all mixed together and without proper classification, it is frequently confusing to locate a particular one, either just received or under composition.

It is therefore an objective of the present invention to provide a system for processing simultaneous computer information messages in a computer that organizes the messages collectively and systematically for optimized user mail service efficiency and convenience.

It is another objective of the present invention to provide a system for processing simultaneous computer information messages in a computer that organizes the messages collectively and systematically to avoid user confusion among the presented messages.

The present invention achieves the above-identified objectives by providing an information message processing system for processing simultaneous information messages for users of a computer running an application software program under a host operating system. The information message processing system comprises a front-end unit and a back-end unit. The front-end unit comprises a user interface for interfacing the user to the computer. The back-end unit comprises a message access request management module, a user request analysis module, a message processing module, a display send status module and a message send/receive module. The message access request management module receives information message access requests requesting for received messages as issued by the user and relayed by the user interface, and further assigns to the user request analysis module for determining a received information message for display. The user request analysis module resolves the request and relays the resolved message to the message processing module for processing. The message processing module relays the processed message back to the user interface of the front-end unit for display to the user. The message access request management module also receives information message access requests requesting for messages to be sent as issued by the user and relayed by the user interface and assigns to the display send status module for determining an information message to be sent for display. The display send status module resolves the request and relays the resolved message to the message send/receive module for processing. The message send/receive module then relays the processed message back to the user interface of the front-end unit or display to the user.

In a computer running an application software program under a host operating system, the application software program comprising a front-end unit that comprises a user interface for interfacing the user to the computer and a back-end unit that comprises a message access request management module, a user request analysis module, a message processing module, a display send status module and a message send/receive module, the present invention further provides a method for processing simultaneous information messages comprising the steps of: a) The message access request management module receives information message access requests requesting for received messages as issued by the user and relayed by the user interface and assigns to the user request analysis module for determining a received information message for display. b) The user request analysis module resolves the request and relays the resolved message to the message processing module for processing. c) The message processing module relays the processed message back to the user interface of the front-end unit for display to the user. d) The message access request management module receives information message access requests requesting for messages to be sent as issued by the user and relayed by the user interface and assigns to the display send status module for determining an information message to be sent for display. e) The display send status module resolves the request and relays the resolved message to the message send/receive module for processing. f) The message send/receive module relays the processed message back to the user interface of the front-end unit or display to the user.

### BRIEF DESCRIPTION OF THE DRAWINGS

Other objectives, features, and advantages of this invention will become apparent by way of the following detailed description of the preferred but non-limiting embodiments. The description is made with reference to the accompanying drawings in which:

FIG. 1 is a block diagram illustrating the system configuration of a software system for the processing of simultaneous computer information messages in accordance with a preferred embodiment of the invention;

FIG. 2 is a functional block diagram illustrating the processing of simultaneous information messages in a software system of the invention;

FIG. 3 is a flowchart illustrating the program flow of the front-end processing for the system of FIG. 1;

FIG. 4 is a flowchart illustrating the program flow of the back-end processing for the system of FIG. 1;

FIG. 5 is a flow diagram illustrating the typical prior-art message processing system popping up to the computer user a multiplicity of messages as they are received subsequently;

FIG. 6 is a flow diagram illustrating the managed and organized presentation of simultaneous information messages presented to the computer user in an embodiment of the invention; and

FIG. 7 is a flow diagram illustrating the managed and organized presentation of simultaneous information messages presented to a PDA user in an embodiment of the invention.

### DESCRIPTION OF THE PREFERRED EMBODIMENTS

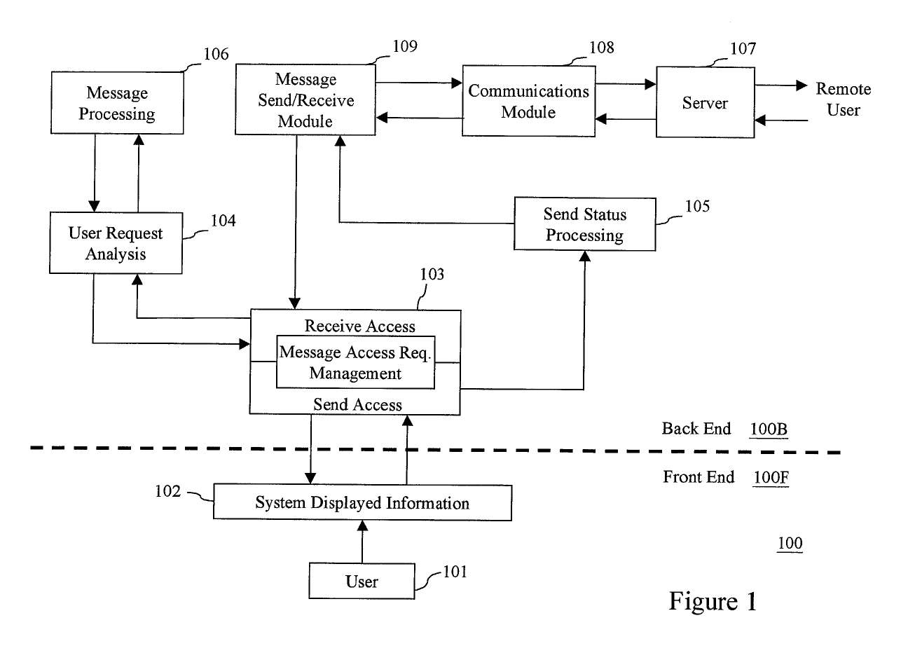

FIG. 1 is a block diagram illustrating the system configuration of a software system for the processing of simultaneous computer information messages in accordance with an embodiment of the invention. The drawing schematically illustrates that a user, generally denoted by the reference numeral 101 in the drawing, accesses the computer information access services provided by a software application system 100, a One-Touch OS™ for example, at the front end of the system via a user interface 102 that comprises, for example, display and input devices. The system 100 exemplified herein comprises a front-end unit and a back-end unit generally identified by the reference numeral 100F and 100B respectively. A phantom line in the drawing generally divides the system among the two units. All the user's access requests at the front end 100F are relayed to the back end 100B of the software system 100 for processing.

As is known in the art, a software application system such as the One-Touch OS™ provides functionalities more than computer information message access services, either electronic mail send/receive and facsimile services. A user-friendly application software program such as the One-Touch OS™ aimed at providing convenience to computer novice users most likely provides other daily-life convenience applications such as Web browsing, recreations, entertaining and so on. This invention, however, concentrates on the access services for computer information messages, in particular, the sending and receiving of electronic mails.

The One-Touch OS™ is a user-friendly and easy-to-use software application program for the convenience of computer novices. The basic software design idea of the One-Touch OS™, as the name implies, is one-touch actuation of software functionalities. Such simple actuation interface is preferred by the majority of computer novice users. The one-touch actuation can be the single-press of a key on the keyboard of the computer. In an example of such an easy-to-use One-Touch OS™ application software, different sets of suitable keys of the keyboard can be assigned for different functionalities of the particular computer application. The principle for these key assignment is simplicity and clarity for computer novices.

An example of such a One-Touch OS™ features many daily-life computer applications aimed at providing hands-on experience and initiating the learning of computer use for computer novices. It has the functionality for processing daily-life computer applications that a computer-novice desires. Functionalities provided by such an easy-to-use application software system include the ability to process handy personal information such as phone numbers and addresses, take notes in texts or in drawings, provide basic communication services including telephone, facsimile, electronic mailing, chatting service over the network, and access to the popular World Wide Web over the Internet. The system also provides easy-to-use application systems for convenient learning and recreational sessions such as tutoring for personal skills such as language and typing, game playing, as well as audio and video playback.

At the back end 100B of the software application system 100 of FIG. 1, the system comprises a message access request management module 103, a user request analysis module 104, a message processing module 106, a display send status module 105, a message send/receive module 109, and a communications module 108. Receiving the user's access requests from the front end 100F, the system 100 examines if the requests is one for the reading/reviewing of the received electronic mail messages or for messages to be sent. This, as is illustrated in the drawing, is performed at the back end 100B of the system.

If the user requests for the reviewing of received mail messages, the specifics of the read-mail request are relayed to the analysis module 104 in order to determine which received mails are to be displayed for review. Once the read-mail request is resolved by the analysis module 104, the corresponding information messages are processed in module 106. These processed mail messages are then relayed back to the user 101 at the front end 100F of the system 100 for review. This can be accomplished by, for example, displaying the messages on the display screen of the user interface 102, as is illustrated in the drawing.

If, on the other hand, the user request is intended for reviewing messages to be sent, as is determined by the message access request management module 103, status information regarding the message-to-be-sent is processed for display to the user by the send-status processing module 105. Again, these send status information are relayed to the user at the front end of the system. Meanwhile, the messages to be sent out may be relayed to the communications module 108 for transmission via the server 107 under control of the message send/receive module 109.

The system 100 is also responsible for receiving from third parties computer information messages including electronic mails. Other users in the network system wherein the system 100 is connected may send messages to the user 101 at front end 100F. The process involves a remote user transmitting mail messages to the communications module 108 via the server 107. The communications module 108 then relays the mail messages to the message send/receive module 109 for sending back to the user interface 102 at the front end 100F for display.

Thus, the information message processing system 100 of FIG. 1 is constructed in accordance with an embodiment of the invention for processing simultaneous information messages for users of a computer running an application software program under a host operating system. The information message processing system 100 comprises a front-end unit 100F and a back-end unit 100B, as is illustrated in the drawing. The front-end unit 100F comprises a user interface 102 for interfacing the user 101 to the computer, and the back-end unit 100B comprises a message access request management module 103, a user request analysis module 104, a message processing module 106, a display send status module 105 and a message send/receive module 109.

The message access request management module 103 receives information message access requests requesting for received messages as issued by the user and relayed by the user interface 102, and further assigns the requests to the user request analysis module 104 for determining a received information message for display. The user request analysis module 104 resolves the request and relays the resolved message to the message processing module 106 for processing. The message processing module 106 relays the processed message back to the user interface 102 at the front-end unit 100F for display to the user 101.

On the other hand, the message access request management module 103 also receives information message access requests requesting for messages to be sent as issued by the user and relayed by the user interface 102, and assigns those requests to the display send status module 105 for determining an information message to be sent for display. The display send status module 105 resolves the request and relays the resolved message to the message send/receive module 109 for processing. The message send/receive module 109 then relays the processed message back to the user interface 102 at the front-end unit 100F or display to the user 101.

Note that the server 107 may be a server residing on the network in which the computer system is connected. The communications module 108 of the back-end unit 100B of the system 100 of FIG. 1 relays the message resolved by the display send status module 105 forward to the server 107 for sending onto a network, which may be an intranet in a corporate environment or the Internet.

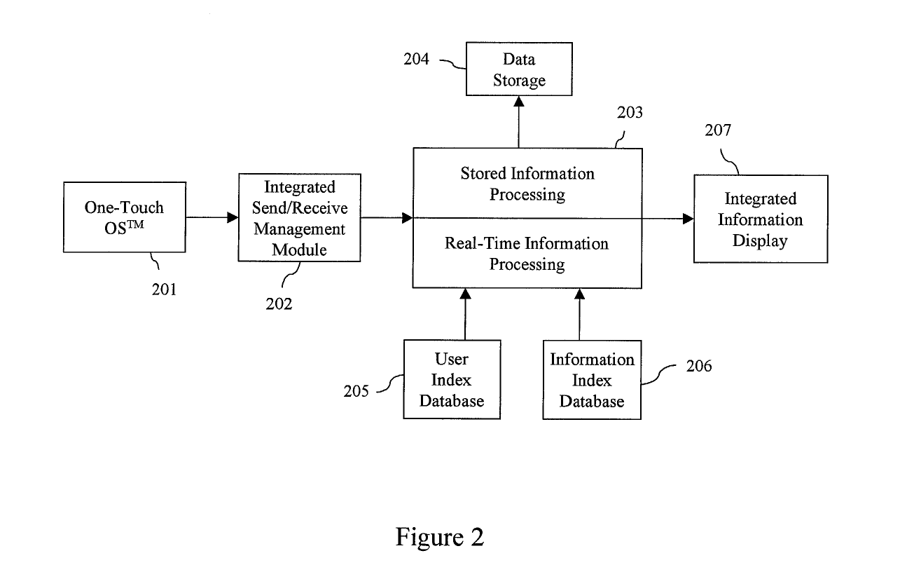

FIG. 2 is a functional block diagram illustrating the processing of simultaneous information messages in a software system of the invention. In this described embodiment, an application software system, generally identified by the reference numeral 201 such as the One-Touch OS™ that provides a set of daily computer applications for experienced and novice computer users alike can be used to provide interface to the user. Services such as computer information access including electronic mail sending and receiving can be accomplished on a computer running this software.

As a user accesses the computer through the One-Touch OS™ 201 and requests for electronic mail access service, the requests are input to an integrated send/receive management module 202. The request of either electronic mail sending or receiving as discriminated by the management module 202 is then relayed to the information message processing module 203. Here the module 203 retrieves user index information from a user index database 205 and information index from the information index database 206. Temporary information in the memory of the system is also retrieved. Information that requires temporary or permanent storage in this process is sent to data storage 204. Based on the database information, the messages requested by the user can be resolved from the message list and can be organized for display to the user by an integrated information display module 207.

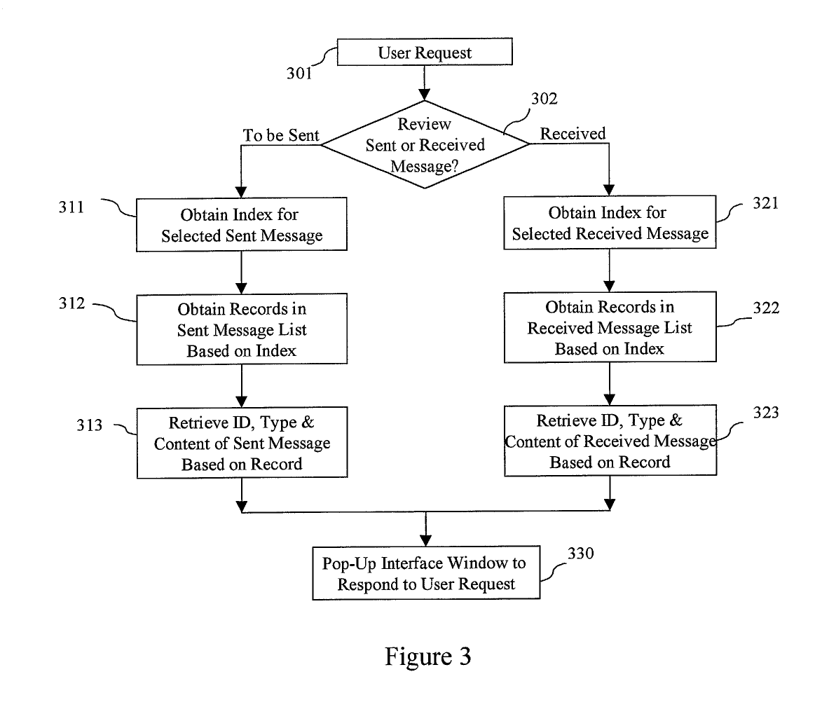

FIG. 3 is a flowchart illustrating the program flow of the front-end processing for the system of FIG. 1. As is illustrated in the flowchart, a user issues request at step 301, which is examined at step 302 to determine if the request is for reviewing a message to be sent or a message that has been received. If review of a message to be sent is desired by the user, the process proceeds to step 311, in which index information for the message to be sent and to be reviewed is obtained. Based on the index information obtained in step 311, the system may proceed to step 312, in which the message records in relation to the selected message to be sent and stored in a list of messages to be sent can be obtained. Then, in step 313, further according to this obtained record, information such as ID of the user, the type of the mail message to send, and the very content of the message itself can all be retrieved. The process then proceeds to step 330, in which a pop-up display window containing all the relevant information for the message to be sent and which the user requests to review can be displayed on the computer screen for the user's review.

On the other hand, if the user requests to review a received computer information message, as determined in step 302, the program flow proceeds from step 302 to step 321, in which index information for the message that has been received and which the user requests to review is obtained. Based on the index information obtained in step 321, the system may then proceed to step 322, in which the message records in relation to the selected received message and stored in a received message list can be obtained. Then, in step 323, based on this obtained record, information such as ID of the message sender, the type of the mail message received, and the content of the message itself can be retrieved The process then proceeds to step 330, in which a pop-up display window containing all the relevant information for the received message which the user requests to review can be displayed for review.

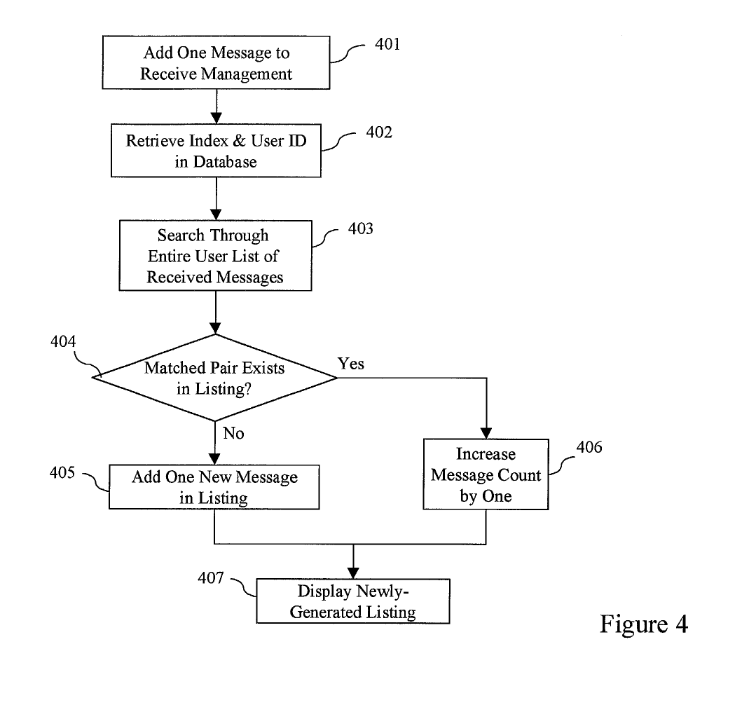

FIG. 4 is a flowchart illustrating the program flow of the back-end processing for the system of FIG. 1. The program flow starts at step 401, in which the receive message management of the system of FIG. 1 adds one message into the operation. Then, at step 402, information including index and user ID of that message is retrieved from the database. Based on this retrieved information, the index in particular, a search is conducted at step 403 that scans through the entire user list that keeps records of user information for messages already received. Then, in step 404, the search result of step 403 is examined to see if the search step has produced a matched result that confirms the existence of matched pair of information in the listing. If the result is negative, the program flow proceeds to step 405, and the new message is added into the listing. The process then concludes at step 407, in which the newly-generated listing is presented to the user. If the test result of step 404 is positive, the process proceeds from step 404 to 406, in which the message count is increased by one, and the process still concludes at step 407, with the newly-generated listing presented to the user.

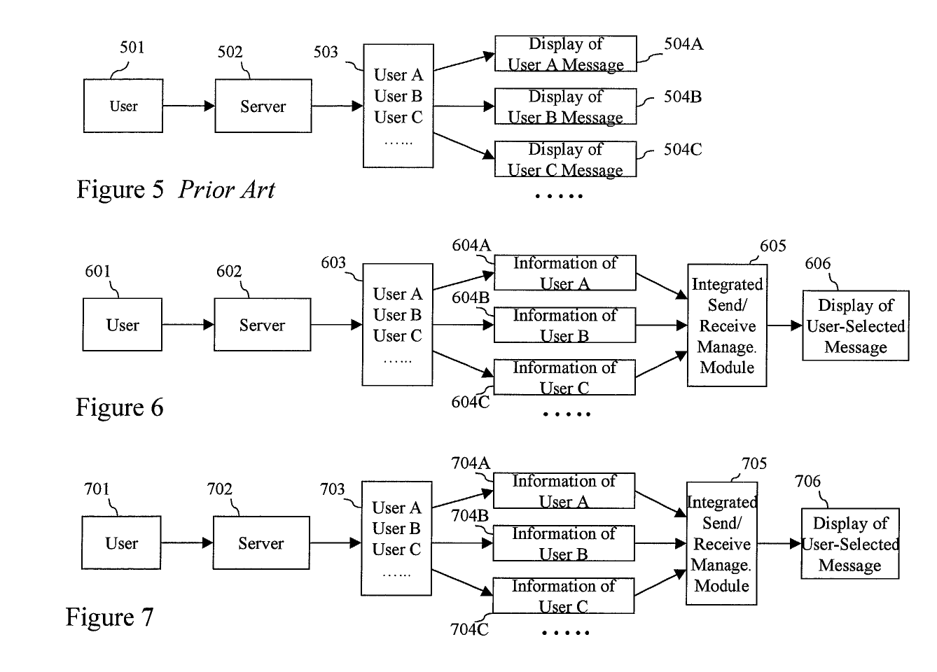

Thus, the system for processing simultaneous computer information messages in a computer that organizes information messages collectively and systematically, as is described in the above paragraphs with reference to FIGS. 1-4, is suitable for optimizing user mail service efficiency and convenience. Confusion caused by complexity among a number of simultaneously-presented messages can also be avoided. Such a software system is suitable for application software programs providing daily-life convenience for experienced and novice computer users alike. When compared to a conventional mail service software program such as schematically described in FIG. 5, the usefulness of the software system of the invention is obvious.

FIG. 5 is a flow diagram illustrating the typical prior-art message processing system popping up to the computer user a multiplicity of messages as they are received subsequently. Many of these conventional information message access service functionalities can be found in the Microsoft Windows environment. In these conventional systems, a user 501 accessing information messages via the use of, an ICQ (“I Seek You”) services under MS Windows for example, implements his or her access via issuing the requests to a server 502. The server 502, based on the user's request, obtains information over the Internet in relation to relevant users A, B, C and so on, as is schematically shown in 503. The system then produces a pop-up window for each of all the relevant information and throws all the multiplicity of information message windows 504A, 504B, 504C and so on to the user. As is well known, finding specific information among a number of windows opened simultaneously and scattered over the virtual desktop of a computer is frequently confusion.

By contrast, FIG. 6 is a flow diagram illustrating the managed and organized presentation of simultaneous information messages presented to a computer user in an embodiment of the invention. In this application software system, utilizing a One-Touch OS™ for example that is capable of efficient management and organization of simultaneous information messages, a user 601 accessing information messages via the use of, an ICQ service for example, implements his or her access via issuing the requests to a server 602. The server 602, based on the user's request, obtains information from the Internet in relation to relevant users A, B, C and so on, as is schematically shown in 603. Then, instead of producing one pop-up window for each of all the pieces of relevant information 604A, 604B, 604C and so on, the One-Touch OS™ may exercise its information management and organization capabilities utilizing its integrated send/receive management module 605 (equivalently, block 202 in the system of FIG. 2) and allows the user to select one of the resulted messages for display in one single display window, as is schematically shown in 606. This effectively eliminates confusion caused by the simultaneously-opened multiplicity of windows each containing one different information message.

FIG. 7 is a flow diagram illustrating the managed and organized presentation of simultaneous information messages presented to a PDA user in an embodiment of the invention. In this application software system, utilizing a miniature One-Touch OS™ designed specifically for PDA for example that is capable of management and organization of simultaneous information messages, a user 701 accessing information messages via the use of, an ICQ service for example, implements access via a server 702. Based on the user's request, the server 702 obtains information from the net in relation to relevant users A, B, C and so on as is shown in 703. Then, the relevant information 704A, 704B, 704C and so on may be managed and organized by the miniature One-Touch OS™ utilizing its integrated send/receive management module 705 (equivalently block 202 in the system of FIG. 2). The system allows the user to select one of the resulted messages for display in one single display window (which is relatively tiny in PDA's as compared to regular computer displays), as is schematically shown by 706.

In summary, according to a preferred embodiment of the invention, in a computer running an application software program by a user under a host operating system, such as the software system with a configuration illustrated in the system of FIG. 1, wherein the application software program comprises a front-end unit 100F that comprises a user interface 102 for interfacing the user 101 to the computer, and a back-end unit 100B that comprises a message access request management module 103, a user request analysis module 104, a message processing module 106, a display send status module 105, and a message send/receive module 109, the method for processing simultaneous information messages comprises the following steps.

First, in the case that the user requests for an information message that has been received, the message access request management module 103 receives these information message access requests requesting for received messages as issued by the user 101 and relayed by the user interface 102, and assigns the requests to the user request analysis module 104 for determining a received information message for display.

Then, the user request analysis module 104 resolves the request and relays the resolved message to the message processing module 106 for processing. The message processing module 106 then relays the processed message back to the user interface 102 of the front-end unit 100F for display to the user 101.

In another case, if the user requests for an information message that is to be sent out, the message access request management module 103 receives information message access requests requesting for messages to be sent out as issued by the user 101 and relayed by the user interface 102 and assigns to the display send status module 105 for determining an information message to be sent for display. The display send status module 105 then resolves the request and relays the resolved message to the message send/receive module 109 for processing. The message send/receive module 109 then relays the processed message back to the user interface 102 of the front-end unit 100F or display to the user 101.

While the above is a full description of the specific embodiments, various modifications, alternative constructions and equivalents may be used. Therefore, the above description and illustrations should not be taken as limiting the scope of the present invention which is defined by the appended claims.

What is claimed is:

1. An information message processing system for processing simultaneous information messages for users of a computer running an application software program by a user under a host operating system, said information message processing system comprising:
a front-end unit comprising a user interface for interfacing said user to said computer; and
a back-end unit comprising a message access request management module, a user request analysis module, a message processing module, a display send status module, and a message send/receive module, wherein
said message access request management module receiving information message access requests requesting for received messages as issued by said user and relayed by said user interface and assigning to said user request analysis module for determining a received information message for display, said user request analysis module resolving said request and relaying said resolved message to said message processing module for processing, and said message processing module relaying said processed message back to said user interface of said front-end unit for display to said user; and
said message access request management module receiving information message access requests requesting for messages to be sent as issued by said user and relayed by said user interface and assigning to said display send status module for determining an information message to be sent for display, said display send status module resolving said request and relaying said resolved message to said message send/receive module for processing, and said message send/receive module relaying said processed message back to said user interface of said front-end unit or display to said user.

2. The information message processing system of claim 1, wherein said back-end unit further comprises a communications module for relaying said message resolved by said display send status module for sending onto a network via a server connected to said computer.

3. The information message processing system of claim 1, wherein said application software program is a user-friendly application software system incorporating a plurality of simple interfaces for intuitive access by computer users.

4. The information message processing system of claim 1, wherein said application software program is a user-friendly One-Touch OS application software system for processing daily-life computer applications for computer users.

5. The information message processing system of claim 4, wherein said One-Touch OS application software system processes handy personal information including phone numbers and addresses.

6. The information message processing system of claim 4, wherein said One-Touch OS application software system takes notes.

7. The information message processing system of claim 4, wherein said One-Touch OS application software system provides communication services.

8. The information message processing system of claim 4, wherein said One-Touch OS application software system provides chatting service over the Internet.

9. The information message processing system of claim 4, wherein said One-Touch OS application software system provides access to the World Wide Web over Internet.

10. The information message processing system of claim 4, wherein said One-Touch OS application software system provides language tutoring to computer users.

11. The information message processing system of claim 4, wherein said One-Touch OS application software system provides typing tutoring to computer users.

12. The information message processing system of claim 4, wherein said One-Touch OS application software system provides game playing to computer users.

13. The information message processing system of claim 4, wherein said One-Touch OS application software system provides multimedia playback.

14. The information message processing system of claim 4, wherein said One-Touch OS application software system is capable of processing handy personal information including phone numbers and addresses, taking notes in texts and in drawings, providing communication services including telephone connections, facsimile transmissions and receptions, electronic mailing, chatting service over the Internet, accessing the World Wide Web over the Internet, providing language tutoring and typing tutoring to computer users, providing game play to computer users, and providing audio and video playback.

15. An information message processing system for processing simultaneous information messages for users of a computer running an application software program by a user under a host operating system, said information message processing system comprising:
a front-end unit comprising a user interface for interfacing said user to said computer; and
a back-end unit comprising a message access request management module, a user request analysis module, a message processing module, a display send status module, a message send/receive module, and a communications module, wherein
said message access request management module receiving information message access requests requesting for received messages as issued by said user and relayed by said user interface and assigning to said user request analysis module for determining a received information message for display, said user request analysis module resolving said request and relaying said resolved message to said message processing module for processing, and said message processing module relaying said processed message back to said user interface of said front-end unit for display to said user;
said message access request management module receiving information message access requests requesting for messages to be sent as issued by said user and relayed by said user interface and assigning to said display send status module for determining an information message to be sent for display, said display send status module resolving said request and relaying said resolved message to said message send/receive module for processing, said message send/receive module relaying said processed message back to said user interface of said front-end unit or display to said user, and said communications module relaying said message resolved by said display send status module for sending onto a network via a server connected to said computer.

16. The information message processing system of claim 15, wherein said application software program is a user-friendly application software system incorporating a plurality of simple interfaces for intuitive access by computer users.

17. In a computer running an application software program by a user under a host operating system, said application software program comprising a front-end unit that comprises a user interface for interfacing said user to said computer and a back-end unit that comprises a message access request management module, a user request analysis module, a message processing module, a display send status module, and a message send/receive module, a method for processing simultaneous information messages comprising the steps of:
a) said message access request management module receiving information message access requests requesting for received messages as issued by said user and relayed by said user interface and assigning to said user request analysis module for determining a received information message for display;
b) said user request analysis module resolving said request and relaying said resolved message to said message processing module for processing;
c) said message processing module relaying said processed message back to said user interface of said front-end unit for display to said user;
d) said message access request management module receiving information message access requests requesting for messages to be sent as issued by said user and relayed by said user interface and assigning to said display send status module for determining an information message to be sent for display;
e) said display send status module resolving said request and relaying said resolved message to said message send/receive module for processing; and
f) said message send/receive module relaying said processed message back to said user interface of said front-end unit or display to said user.

18. The method of processing simultaneous information messages of claim 17, wherein said application software program is a user-friendly application software system incorporating a plurality of simple interfaces for intuitive access by computer users.

19. The method of processing simultaneous information messages of claim 18, wherein said application software program is a user-friendly One-Touch OS application software system for processing daily-life computer applications for computer users.

20. The method of processing simultaneous information messages of claim 18, wherein said One-Touch OS application software system processes handy personal information including phone numbers and addresses.

21. The method of processing simultaneous information messages of claim 18, wherein said One-Touch OS application software system takes notes.

22. The method of processing simultaneous information messages of claim 18, wherein said One-Touch OS application software system provides communication services.

23. The method of processing simultaneous information messages of claim 18, wherein said One-Touch OS application software system provides chatting service over the Internet.

24. The method of processing simultaneous information messages of claim 18, wherein said One-Touch OS application software system provides access to the World Wide Web over Internet.

25. The method of processing simultaneous information messages of claim 18, wherein said One-Touch OS application software system provides language tutoring to computer users.

26. The method of processing simultaneous information messages of claim 18, wherein said One-Touch OS application software system provides typing tutoring to computer users.

27. The method of processing simultaneous information messages of claim 18, wherein said One-Touch OS application software system provides game playing to computer users.

28. The method of processing simultaneous information messages of claim 18, wherein said One-Touch OS application software system provides multimedia playback.

29. The method of processing simultaneous information messages of claim 19, wherein said One-Touch OS application software system is capable of processing handy personal information including phone numbers and addresses, taking notes in texts and in drawings, providing communication services including telephone connections, facsimile transmissions and receptions, electronic mailing, chatting service over the Internet, accessing the World Wide Web over the Internet, providing language tutoring and typing tutoring, providing game playing, and providing audio and video playback.
